(19) United States
(12) Patent Application Publication
(10) Pub. No.: US 2011/0219387 A1
(43) Pub. Date: Sep. 8, 2011

(54) Interactive Remote Troubleshooting of a Running Process

(75) Inventors: Victor Boctor, Redmond, WA (US); Oleg Ouliankine, Redmond, WA (US); Yamin Wang, Bellevue, WA (US)

(73) Assignee: MICROSOFT CORPORATION, Redmond, WA (US)

(21) Appl. No.: 12/717,560

(22) Filed: Mar. 4, 2010

(51) Int. Cl. G06F 11/07; G06F 3/00; G06F 13/00; G06F 9/44; G06F 9/46

(52) U.S. Cl. 719/330; 714/E11.029

(57) ABSTRACT

A computing device includes a registered target software process including at least one software component configured to support functionality of the at least one target software and identifiable by a unique component identification parameter, and a first communication module configured to receive a data access request comprising a request to access internal process data of the at least one software component. The process also includes an access manager module linked to the at least one software component and the first communication module, the access manager being configured to receive the data access request from the first communication module and call an interface implementation of the software component that executes the targeted data access request and returns requested internal process data to the access manager, wherein the internal process data is retrieved as the at least one software components is executing on the computing device.

### BACKGROUND

When troubleshooting a software process, acquisition of internal data of the process running in memory may be required when external data is insufficient to diagnose and fix the problem. This may introduce process downtime, as acquisition of internal data typically requires suspension of all active threads of the process, followed by a memory dump of all data in memory of the suspended process and analysis of the acquired data.

### SUMMARY

The present application is directed to systems and methods for accessing internal process data of a running software process executing on a computing device in a networked computing system environment.

In one aspect, a computing device includes a processing unit, and a system memory connected to the processing unit, the system memory including instructions that, when executed by the processing unit, cause the processing unit to register at least one target software process configured to implement a service residing on the computing device. The registered target software process comprises: at least one software component configured to support functionality of the at least one target software and identifiable by a unique component identification parameter; a first communication module configured to receive a data access request comprising a request to access internal process data of the at least one software component; and an access manager module linked to the at least one software component and the first communication module, wherein the access manager is configured to receive the data access request from the first communication module and call an interface implementation of the at least one software component that executes the targeted data access request and returns requested internal process data to the access manager, wherein the internal process data is retrieved as the at least one software components is executing on the computing device.

In another aspect, a method for accessing internal process data of a running software process executing on at least one computing device in a networked computing system environment includes: receiving a data access request at the at least one computing device; routing the data access request to at least one registered target software process executing on the computing device; routing the data access request to at least one software component of the at least one registered target software process, wherein the at least one software component is configured to support functionality of the at least one target software process; capturing internal process data of the at least one software component as the at least one software component is executing on the at least one computing device; and returning the captured internal process data to the at least one registered target software process.

In yet another aspect, a computer readable storage medium having computer-executable instructions that, when executed by a computing device, cause the computing device to perform steps comprising: receiving a data access request at the at least one computing device as a remote procedure call; analyzing a process identification parameter of the data access request; routing the data access request to at least one registered target software process executing on the computing device in accordance with the process identification parameter; analyzing one or more unique component identification parameters of the data access request; routing the data access request to at least one software component of the at least one registered target software process in accordance with the one or more unique component identification parameters, wherein the at least one software component is configured to support functionality of the at least one target software process; calling an interface implementation of the at least one software component configured to capture the internal process data of the at least one software component as the at least one software component is executing on the at least one computing device, wherein the internal process data comprises one of structured and unstructured internal process data; returning the captured internal process data to the at least one registered target software process; and formatting the captured internal process data in accordance with a predefined formatting parameter of the data access request.

This Summary is provided to introduce a selection of concepts, in a simplified form, that are further described below in the Detailed Description. This Summary is not intended to identify key or essential features of the claimed subject matter, nor is it intended to be used in any way to limit the scope of the claimed subject matter.

### DESCRIPTION OF THE DRAWINGS

Aspects of the present disclosure may be more completely understood in consideration of the following detailed description of various embodiments in connection with the accompanying drawings.

FIG. 1 is a flowchart of an example method for accessing internal process data of a running software application.

FIG. 2 shows an example networked computing environment.

FIG. 3 shows an example computing device from the environment of FIG. 2.

FIG. 4 shows example client applications of the client device of FIG. 2.

FIG. 5 shows example communications between an example client device and an example server device.

FIG. 6 shows a flowchart for an example method for discovering available internal process data of a running software application or service.

FIG. 7 shows a flowchart for an example method for automating access to internal process data of a running software application or service.

### DETAILED DESCRIPTION

The present application is directed to systems and methods for accessing internal process data of a running software process executing on a computing device in a networked computing system environment.

In the examples provided herein, data that is “internal” to a running software process corresponds to data stored in memory as the software process is executing. Data that is “external” to a running software process corresponds to data that is tracked or recorded relating to the execution of a software process, such as data logging, event logging, and others.

Example software processes that leverage the systems and methods of the present disclosure integrate with an access manager configured to expose a secure, remote access entry point for respective processes to accept and execute requests from a remote computing device. The remote computing device includes a client application that provides an interface for a user or other application to create data access requests. The client application connects to the access manager to submit data access requests for execution. The access manager collects the response and returns the response to the remote computing device for subsequent actions, such as for viewing, post-processing, analysis, and others.

The following example embodiments are described herein with respect to Microsoft Exchange Server from Microsoft Corporation of Redmond, Wash. However, the systems and methods of the present disclosure are applicable to any situation in which it is desirable to access internal data of a running process with minimal impact to performance or uptime of a target process.

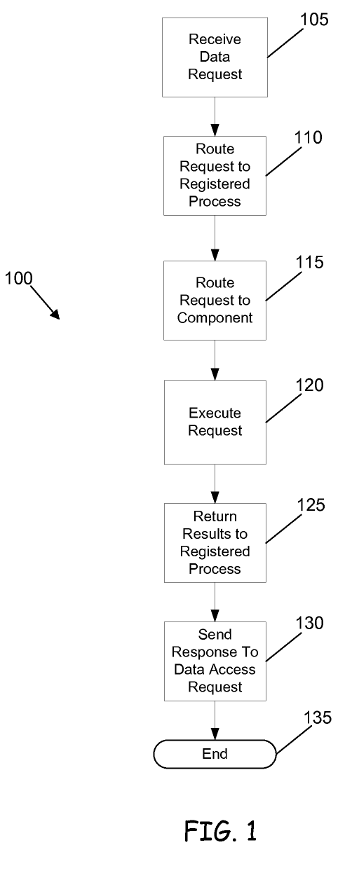

FIG. 1 shows an example method 100 for accessing internal process data of a running software application or service. In general, the example method 100 provides on-demand read-write access to internal process data without suspension of all threads of the running software application. In example embodiments, “on-demand” access corresponds to an up-to-date provision of services. The example method 100 additionally provides a single command capability in which multiple computing devices may be queried for internal process data via a single pipelined command, along with automated post-processing capabilities that may be implemented as desired, such as by scripting or other facility.

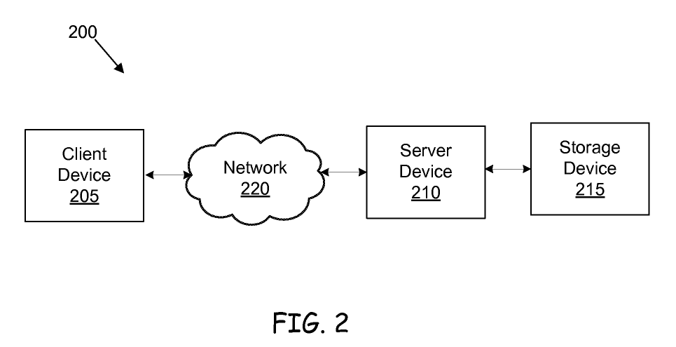

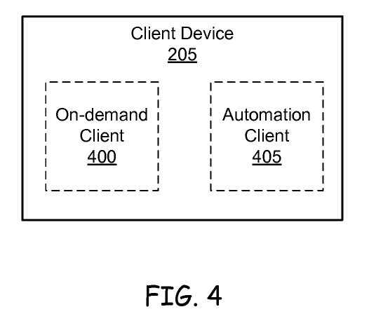

The example method 100 begins at a receive module 105 when a data access request is received at the server device from a client application executing on a remote client device, such as described below with respect to FIG. 4. The data access request is generally formatted to permit for the request and exchange of data in a distributed computing environment, such as an environment described below with respect to FIG. 2. For example, in some embodiments, the data access request is formatted to conform to Remote Procedure Call (RPC) protocol or an otherwise analogous protocol to enable the remote client device to invoke functionality residing on the server device of the example method 100.

In the example embodiment, the client application may be implemented as a static implementation that does not require any changes or notification when one or more business processes of the server device change. Additionally, RPC entry point vectors (EPV) may be utilized to permit multiple applications or services implementing a similar RPC interface to be reachable via a single pipelined command. Other embodiments are possible as well.

Operational flow then proceeds to a first routing module 110. The example first routing module 110 is configured to route the data access request to at least one registered software process executing on the server device. In example embodiments, a registered software process corresponds to one or more logical modules of software executing on the server device configured to implement a specific service of the business processes of the server device. The Edge Transport service for Microsoft Exchange Server from Microsoft Corporation, which at least handles all Internet-facing mail flow in a Microsoft Exchange implementation, is one example of a registered software process. Other types of registered software processes are possible.

In the example embodiment, the first routing module 110 is configured to analyze a process identification parameter of the data access request to determine which registered software process the data access request is to be routed to. Example process identification parameters include a process name, a process identification number (PID), and other parameters that may be used to identity a registered software process. An example process name may include “EdgeTransport” as a designator, while a PID may include a string of one or more integers such as the string “2096” for example. Still other embodiments are possible.

In some embodiments, the first routing module 110 is further configured to send a message to the remote client device requesting a list of unique process identification parameter if multiple registered software processes match information of the data access request.

Operational flow then proceeds to a second routing module 115. The example second routing module 115 is configured to route the data access request to at least one component of the at least one registered software process identified by the first routing module 110. In example embodiments, a component corresponds to one or more logical modules of software executing on the server device that implement or support functionality of a specific service of the business processes of the server device. The Priority Queuing component of the Edge Transport service is an example component in a Microsoft Exchange implementation. The Priority Queuing component enables a sender-defined priority of an email message to influence the processing of the email message by a server running Microsoft Exchange. Other types of components are possible.

In the example embodiment, the second routing module 115 is configured to analyze a unique component identification parameter of the data access request to determine which of one or more components the data access request is to be routed to. In some embodiments, the unique component identification parameter corresponds to a name of a respective component. An example unique component identification parameter may include “Priority Queuing” as a designator. However, other embodiments are possible as well.

Operational flow then proceeds to an execute request module 120. The example execute request module 120 is configured to capture a current state of data of the at least one component identified by the second routing module 115, as the at least one component is running in memory. Example data includes any type of hierarchical, structured, and unstructured data such as, for example, primitive data types, composite data types, arrays, lists, trees, objects, property bags, caches, dictionaries, libraries, configurations, and any other types of structured or unstructured internal process data of a running software application or service.

Operational flow then proceeds to a return results module 125. The example return results module 125 is configured to return data as captured by the execute request module 120 to the corresponding registered software process.

Operational flow then proceeds to a response module 130. The example response module 130 is configured to send the data obtained by the return results module 125 to the remote client device. In some embodiments, the response module 130 is configured to format the data as obtained by the return results module 125, and then return the formatted data to the remote client device. In the example embodiment, the return results module 125 is configured to analyze a formatting parameter of the data access request, such as a structured value or an unstructured value, used to modify the data obtained by the return results module 125. An example formatting parameter may specify that the data obtained by the return results module 125 is to be filtered and formatted prior to sending the data to the remote client device. Still other embodiments are possible as well.

Operational flow then proceeds to an end module 135 corresponding to termination of the example method 100.

Referring now to FIG. 2, an example networked computing environment 200 is shown in which aspects of the present disclosure may be implemented. The example environment 200 includes a client device 205, a server device 210, a storage device 215, and a network 220. However, other embodiments of the example environment 200 are possible as well. For example, the environment 200 may generally include more or fewer devices, networks, and other components as desired.

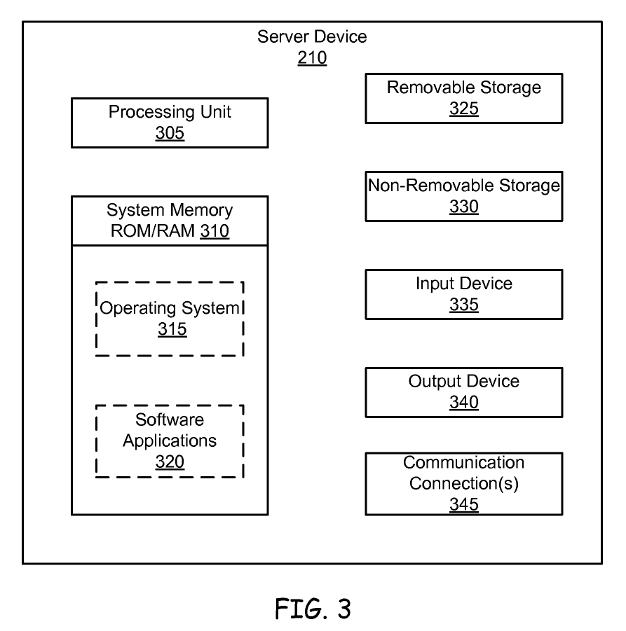

The client device 205 and the server device 210 are general purpose computing devices, as described below in connection with FIG. 3. In example embodiments, the server device 210 is a business server that implements business processes. Example business processes include messaging and collaborative processes, data management processes, and others. Microsoft Exchange Server from Microsoft Corporation is an example of a business server that implements messaging and collaborative business processes in support of electronic mail, calendaring, and contacts and tasks features, in support of mobile and web-based access to information and in support of data storage. However, other embodiments are possible as well. In some embodiments, the server device 210 includes of a plurality of interconnected server devices operating together to implement business processes.

The storage device 215 is a data storage device such as a relational database or any other type of persistent data storage device. The storage device 215 stores data in a predefined format such that the server device 210 can query, modify, and manage data stored thereon. Examples of such a data storage device include recipient mailbox stores, and address services such as ACTIVE DIRECTORY® directory service from Microsoft Corporation. In some embodiments, the storage device 215 includes a plurality of data storage devices logically grouped together into an interconnected “Farm” configuration. Other embodiments of the storage device 215 are possible.

The network 220 is a bi-directional data communication path for data transfer between one or more devices. In the example shown, the network 220 establishes a communication path for data transfer between the client device 205 and the server device 210. In general, the network 220 can be of any of a number of wireless or hardwired WAN, LAN, Internet, or other packet-based communication networks such that data can be transferred among the elements of the example environment 200. Other embodiments of the network 220 are possible as well.

Referring now to FIG. 3, the server device 210 of FIG. 1 is shown in further detail. As mentioned above, the server device 210 is a general purpose computing device. Example general purpose computing devices include a desktop computer, laptop computer, personal data assistant, smartphone, and other computing devices.

The server device 210 includes at least one processing unit 305 and system memory 310. The system memory 310 can store an operating system 315 for controlling the operation of a computing device. One example operating system 315 is the WINDOWS® operating system from Microsoft Corporation.

The system memory 310 may also include one or more software applications 320 and may include program data. Software applications 320 may include many different types of single and multiple-functionality programs, such as an electronic mail program, a calendaring program, an Internet browsing program, a spreadsheet program, a program to track and report information, a word processing program, an instant messaging program, a web conferencing service program, and many others. One example program is the OFFICE® suite of applications from Microsoft Corporation. Another example program is a server, such as Exchange Server, also from Microsoft Corporation. Still another example program includes Windows POWERSHELL®, also from Microsoft Corporation.

The system memory 310 can include computer readable media. Examples of computer readable media include computer readable storage media and communications media.

Computer readable storage media include physical media such as, for example, magnetic disks, optical disks, or tape. Such additional storage is illustrated in FIG. 3 by removable storage 325 and non-removable storage 330. Computer readable storage media can include physical volatile and nonvolatile, removable and non-removable media implemented in any method or technology for storage of information, such as computer readable instructions, data structures, program modules, or other data. Computer readable storage media can also include, but is not limited to, RAM, ROM, EEPROM, flash memory or other memory technology, CD-ROM, DVD or other optical storage, magnetic cassettes, magnetic tape, magnetic disk storage or other magnetic storage devices, or any other medium which can be used to store the desired information and which can be accessed by server device 210. Any such computer storage media may be part of or external to the server device 210.

Communication media may typically be embodied by computer readable instructions, data structures, program modules, or other data in a modulated data signal, such as a carrier wave or other transport mechanism, and includes any information delivery media. The term “modulated data signal” means a signal that has one or more of its characteristics set or changed in such a manner as to encode information in the signal. By way of example, communication media includes wired media such as a wired network or direct-wired connection, and wireless media such as acoustic, RF, infrared and other wireless media.

The server device 210 can also have any number and type of input devices 335 and output devices 340. Example input devices 335 include a keyboard, mouse, pen, voice input device, touch input device, and others. Example output devices 340 include a display, speakers, printer, and others. The server device 210 can also include a communication connection 345 configured to enable communications with other computing devices over a network (e.g., network 220) in a distributed computing environment.

In example embodiments, the client device 205 of FIG. 2 is configured similar to the server device 210 described above.

Referring now additionally to FIG. 4, the client device 205 of FIG. 2 also includes one or more different types of client applications configured to enable access to internal process data of a running software application or service residing on the server device 210. The client applications include one or more logical modules of software executing on the client device 205. Example client applications include an on-demand client 400 and an automation client 405. However, other client applications are possible.

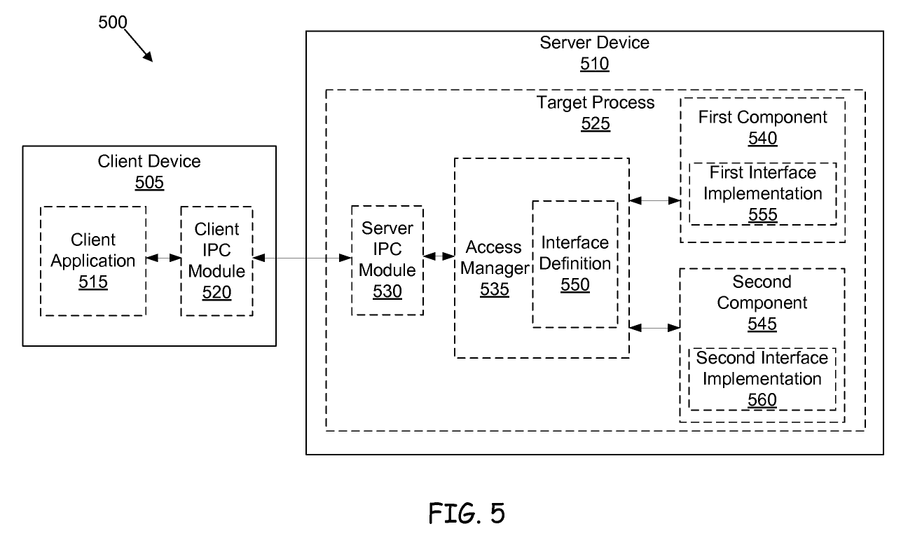

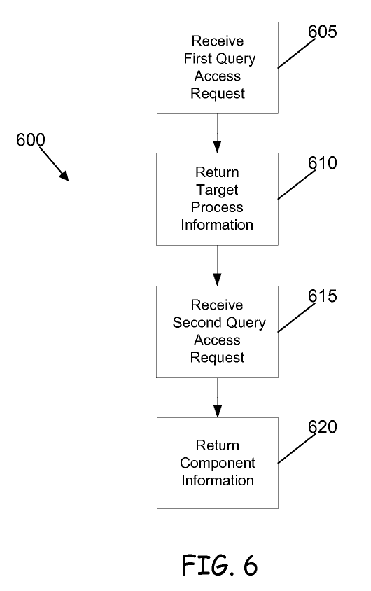

The example on-demand client 400 is configured to enable a user to generate a data access request to access internal process data of a running software application or service residing on the server device 210. In some embodiments, the data access request includes a targeted data request. A targeted data request includes an explicit request for read-write access to internal process data of at least one specific component of a target process residing on the server device 210. An example of a targeted data request is described below in connection with FIG. 5. In other embodiments, the data access request includes a query data request. A query data request includes a request to discover available internal process data of a running software application or service residing on the server device 210. An example of a query data request is described below in connection with FIG. 6.

The example on-demand client 400 may be implemented as any type of software application configured to: a) enable generation of a data access request; b) receive internal process data from the server device 210 in response to the data access request; and c) operate on the received data as desired, such as for displaying the received data, post-processing the received data, and others.

For example, in one embodiment, the on-demand client 400 includes the Windows POWERSHELL® task-based command-line shell and scripting language from Microsoft Corporation. The Windows POWERSHELL® is one example of a command-line interface that enables a user to perform tasks by execution of cmdlets, compositions of cmdlets, scripts, standalone applications, and others. In the example embodiment, Windows POWERSHELL® enables a user to generate a data access request via cmdlets, receive data from the server device 210 in response to the data access request, and operate on the received data as desired, such as for displaying the received data, post-processing the received data.

Other types of command-line implementations of the on-demand client 400 are possible as well. For example, the on-demand client 400 may be implemented as a command-line interface modified to provide access to internal process data of a running software application or service residing on the server device 210, as if the server device 210 were configured as a relational database or any other type of persistent data storage device. For example, in one embodiment, the on-demand client 400 may be modified to receive a data access request formatted according to an SQL syntax typically used to query a SQL SERVER® as provided by Microsoft Corporation.

In the example embodiment, a user interacting with the on-demand client 400 would be provided access to internal process data of a running software application or service residing on the server device 210 by entering a data access request as a SQL command. Subsequently, the on-demand client 400 would receive data from the server device 210 in response to the data access request, and present the data in accordance as an SQL output. Still other embodiments are possible as well.

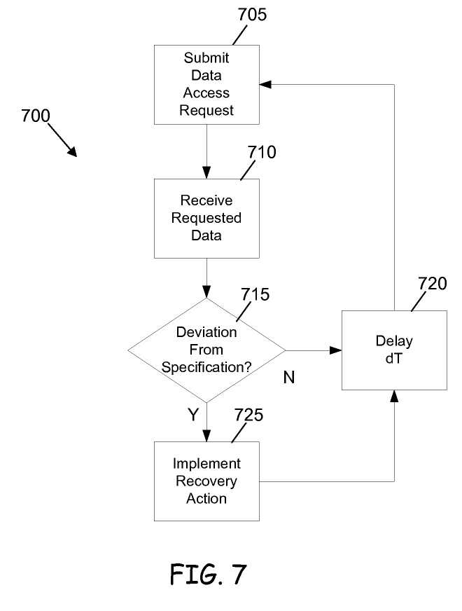

The example automation client 405 is configured to provide automated access to internal process data of a running software application or service residing on the server device 210 for automated testing applications, monitoring application, reporting applications, and other applications as desired. The example automation client 405 may be implemented as any type of software application configured to: a) automatically generate a targeted data access request; b) receive internal process data from the server device 210 in response to the data access request; c) evaluate the received data; and d) implement issue mitigation techniques to a respective running software application or service based on the state of the data. An example of automatically accessing internal process data of a running software application or service residing on a server device and taking action upon identification of errors within the internal process data is described below in connection with FIG. 7.

Referring now to FIG. 5, a schematic block diagram 500 illustrates example communications between an example client device and an example server device in accordance with the present disclosure. The example schematic block diagram 500 includes a client device 505 and a server device 510. However, other configurations are possible. For example, the schematic block diagram 500 may generally include more or fewer client devices, server devices, and other components as desired.

The example client device 505 is configured similar to the client device 205 described above with respect to FIG. 2 and FIG. 3. In the example shown, the client device 505 includes a client application 515 and a client inter-process communication (IPC) module 520. In general, the example client application 515 is configured similar to the example client applications (i.e., on-demand client 400, automation client 405) described above with respect to FIG. 4. The example client IPC module 520 includes one or more logical modules of software executing on the client device 505 configured to permit for exchange of data between one or more target software processes of the example server device 510, as described in further detail below.

The example server device 510 is configured similar to the server device 210 described above with respect to FIG. 2 and FIG. 3. In the example shown, the server device 510 includes a target process 525 that includes one or more logical modules of software executing on the server device 510 configured to implement a specific software service residing on the server device 510. The Edge Transport service for Microsoft Exchange Server from Microsoft Corporation is one example of a software service. The example target process 525 is registered with the business processes of the server device 510 and is generally identifiable via any number of process identification parameters such as, for example, a process name (e.g., “EdgeTransport”), a PID (e.g., “2096”), and others. Other embodiments of the server device 510 are possible. For example, the server device 510 may generally include any number of target processes as desired.

The example target process 525 includes a server inter-process communication (IPC) module 530, an access manager 535, a first software component 540, and a second software component 545. However, other embodiments of the target process 525 are possible as well. For example, the target process 525 generally includes a plurality of software components, and as such, the first software component 540 and the second software component 545 comprise a subset of all software components of the target process.

The example server IPC module 530 includes one or more logical modules of software executing on the server device 510 configured to interface with the client IPC module 520 to permit exchange of data therebetween. In some embodiments, the client IPC module 520 and the server IPC module 530 are configured to communicate via remote procedure calls (RPC). In the example embodiment, RPC entry point vectors (EPV) may be utilized to permit multiple target processes implementing a similar server IPC module 530 to be reachable via a single pipelined command. Other embodiments are possible as well. For example, the client IPC module 520 and the server IPC module 530 may be configured to communicate via any type of inter-process communication technique as desired.

The example access manager 535 is linked to the server IPC module 530 and includes one or more logical modules of software executing within the target process 525 configured to handle a data access request as sent from the client application 515. For example, in one embodiment, the access manager 535 includes an interface definition 550 comprising a set of named operations that may be invoked by the client application 515 to access internal process data of the first software component 540 and the second software component 545, as described further below. In some embodiments, the access manager 535 is implemented as a library to which the target process 525 links. In other embodiments, the access manager 535 is implemented as an internal software component of target process 525. Still other embodiments are possible as well.

The example first software component 540 and the example second software component 545 are each linked to the access manager 535. The first software component 540 and the second software component 545 each include one or more logical modules executing within the target process 525 that support functionality of the target process 525. The example first software component 540 and second software component 545 are registered with the target process 525 and are each generally identifiable via a unique process identification parameter, such as a component name. An example component name may include “TransportCommunication” as a designator. Still other embodiments are possible.

In one embodiment, a targeted data access request is generated by the client application 515 requesting targeted access to internal process data of the first software component 540 and the second software component 545, as the respective components 540, 545 are executing in memory of the server device 510. In the example embodiment, the data access request is “targeted” as the first software component 540 and the second software component 545 comprise a subset of all software components of the target process, as mentioned above. In some embodiments, the targeted data access request additionally includes instructions to update the respective components 540, 545. Still other embodiments are possible as well.

Configuration data is one example of internal process data of the first software component 540 and the second software component 545. In the example embodiment, the targeted data access as entered into the client application by a user may include a command such as “Get-ExchangeDiagnosticInfo-Process EdgeTransport-Argument Config” command. However, other embodiments are possible as well.

In the example embodiment, the access manager 535 is configured to receive the example targeted data access request (e.g., “Get-ExchangeDiagnosticInfo-Process EdgeTransport-Argument Config”) via the communication connection established by the client IPC module 520 and the server IPC module 530. Upon receiving the targeted data access request, the access manager 535 is configured to call a first interface implementation 555 of the first software component 540 and additionally call a second interface implementation 560 of the second software component 545. In the example embodiment, the first software component 540 and the second software component 545 are each pre-compiled with the target process 525 to support the “Config” argument.

Additionally, the access manager 535 is pre-compiled with the target process to provide the above-mentioned functionality and further include the interface definition 550. However, other embodiments are possible as well. For example, in addition to a “Config” argument, other example arguments the first software component 540 and the second software component 545 may be pre-compiled to support include a “basic” argument, a “verbose” argument, a “help” argument, and other type of customized argument that may provide access to internal process data of the first software component 540 and the second software component 545 as desired.

The first interface implementation 555 executes the targeted data access request and returns the requested data to the access manager 535. Similarly, the second interface implementation 560 executes the targeted data access request returns the requested data to the access manager 535. Subsequently, the access manager 535 is configured to format the respective returned data as desired, and send the formatted internal process data to the client application 515 via the communication connection established by the client IPC module 520 and the server IPC module 530.

Referring now to FIG. 6, an example method 600 for discovering available internal process data of a running software application or service is shown according to the principles of the present disclosure. In example embodiments, the example method 600 is implemented on a server device configured similar to the server device 510 described above in connection with FIG. 5. However, other embodiments are possible as well.

The example method 600 begins at an operation 605, in which the server device receives a first query access request including a command to surface registered software processes executing on the server device. In some embodiments, the first query request is received from a client application executing on a client device such as the client device 505 described above in connection with FIG. 5. An example first query access request may include a “Get-ExchangeDiagnosticInfo” command. However, other embodiments are possible.

Operational flow then proceeds to an operation 610. At operation 610, the server device returns a response to the client application executing on a client device containing information of the registered software processes executing on the server device. In some embodiments, the response is formatted as an XML document and includes at least a plurality of information of each registered software process executing on the server device. An example response may include an XML document such as:

<Diagnostics>

<ProcessLocater>

<count>3</count>
<Process>

<id>2096</id>
<name>EdgeTransport</name>

</Process>
<Process>

<id>3340</id>
<name>Microsoft.Exchange.ServiceHost</name>

</Process>
<Process>

<id>13444</id>
<name>MSExchangeMailSubmission</name>

</Process>

</ProcessLocater>

</Diagnostics>

In the example embodiment, each registered software process executing on the server device is identified by an identification parameter. For example, a registered software process “EdgeTransport” as further identified by a PID “2096” identification parameter is identified as executing on the server device. Other embodiments are possible.

Next, at an operation 615, the server device receives a second query access request including a command to surface available components of at least one of the registered software processes surfaced at operation 610. In example embodiments, the second query request is received from the same client application executing on a client device as the first query access request received at operation 605. However, other embodiments are possible. An example second query access request may include a “Get-ExchangeDiagnosticInfo-Process 2096” command. Other embodiments are possible as well.

Operational flow then proceeds to an operation 620. At operation 620, the server device returns a response to the client application executing on the client device containing information of the components of the at least one registered software process specified at operation 615. In some embodiments, the response is formatted as an XML document and includes at least a plurality of information of each component of the at least one registered software process, along with a plurality of information of the at least one registered software process. An example response may include an XML document such as:

<Diagnostics>

<ProcessInfo>

<id>2096</id>
<serverName>EXCH-A-036</serverName>
<threadCount>28</threadCount>
<workingSet>169.8 MB (178,024,448 bytes)</workingSet>

</ProcessInfo>
<Components>

<TransportConfiguration>

<message>Supported arguments(s): config, basic, verbose, help.</ message >

</TransportConfiguration>

</Components>

</Diagnostics>

In the example embodiment, a plurality of information of at least one registered software process, along with a plurality of information of each component of the at least one registered software process are surfaced. For example, the “Get-ExchangeDiagnosticInfo-Process 2096” command surfaced information of the “EdgeTransport” software process. The “EdgeTransport” software process is executing on the “EXCH-A-036” server and includes a thread count of “38” consuming “169.8 MB” of working memory. Additionally, the supported arguments of the “TransportConfiguration” component include a “config” argument, a “basic” argument, a “verbose” argument, and a “help” argument. However, any other type of argument corresponding to internal process data of the “TransportConfiguration” component and other components of the “EdgeTransport” may be specified, customized and categorized as desired to conveniently provide desired internal process data. Still other embodiments are possible.

Referring now to FIG. 7, an example method 700 for automating access to internal process data of a running software application or service is shown. In general, the example method 700 is at least applicable for automated testing applications, monitoring applications, reporting applications, and other applications as desired. In example embodiments, the method 700 is implemented by an automation client executing on a client device configured similar to the client devices 410 and 505 described above in connection with FIG. 4 and FIG. 5. However, other embodiments are possible as well.

The example method 700 begins at an operation 705, at which the automation client generates and sends a targeted data access request to a server device. As mentioned above, a targeted data request includes an explicit request for read-write access to internal process data of at least one specific component of a target process residing on a server device configured as a business server that implements business processes.

Operational flow then proceeds to an operation 710, in which the automated client receives internal process data from the server device in response to the data access request.

Next, at an operation 715, the client application analyzes the internal process data received at operation 710 to determine if the received data deviates from a predefined specification. In example embodiments, a predefined specification corresponds to one or more parameters that respective internal process data is compared against to determine integrity of the respective data.

For example, the client application may evaluate received internal process data to determine if one or more configuration settings in memory are consistent with configuration setting defined in a configuration file that is loaded by a respective component at target process start-up. Another example includes evaluating component memory usage to determine if too many threads of a respective component are processing or locked-up in a certain operation. Still other embodiments are possible as well.

If it is determined that the internal process data received at operation 710 does not deviate from a predefined specification, operation flow proceeds to an operation 720 which corresponds to a time delay operation, dT. Following passage of a predetermined time delay dT, operational flow then returns to operation 705.

If it is determined that the internal process data received at operation 710 does deviate from a predefined specification, operation flow proceeds to an operation 725 in which a predefined recovery action is implemented based on type and severity of deviation of respective internal process data. For example, if the client application determines that one or more configuration settings in memory are inconsistent with configuration setting defined in a configuration file that is loaded by a respective component at target process start-up, the client application may issue a command to the server device to restart a respective target process and reload configuration settings.

Another example includes allocating more memory to a component if it is determined that too many threads are processing or locked-up in a certain operation. Still other examples of a recovery action are possible as well.

Operational flow then proceeds to operation 720 which corresponds to the time delay operation, dT. Following passage of the predetermined time delay dT at operation 720, operational flow returns to operation 705. In this manner, the example method 700 periodically accesses and assesses internal process data of a running software application or service to determine if respective internal process data is consistent with a predefined specification. Upon identifying deviation from the predefined specification, mitigation techniques are implemented in accordance with the type and severity of deviation of respective internal process data.

The example embodiments described herein can be implemented as logical operations in a computing device in a networked computing system environment. The logical operations can be implemented as: (i) a sequence of computer implemented instructions, steps, or program modules running on a computing device; and (ii) interconnected logic or hardware modules running within a computing device.

For example, the logical operations can be implemented as algorithms in software, firmware, analog/digital circuitry, and/or any combination thereof, without deviating from the scope of the present disclosure. The software, firmware, or similar sequence of computer instructions can be encoded and stored upon a computer readable storage medium and can also be encoded within a carrier-wave signal for transmission between computing devices.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computing device, comprising:
a processing unit;
a system memory connected to the processing unit, the system memory including instructions that, when executed by the processing unit, cause the processing unit to register at least one target software process configured to implement a service residing on the computing device, wherein the at least one registered target software process comprises:
at least one software component configured to support functionality of the at least one target software and identifiable by a unique component identification parameter;
a first communication module configured to receive a data access request comprising a request to access internal process data of the at least one software component; and
an access manager module linked to the at least one software component and the first communication module, wherein the access manager is configured to receive the data access request from the first communication module and call an interface implementation of the at least one software component that executes the targeted data access request and returns requested internal process data to the access manager, wherein the internal process data is retrieved as the at least one software components is executing on the computing device.

2. The computing device of claim 1, wherein the data access request comprises a request selected from a group including: a targeted data request including an explicit request for read-write access to internal process data of at least one specific component; and a query data request comprising a request to discover available internal process data of the at least one target software process.

3. The computing device of claim 1, wherein the access manager module is pre-compiled with the at least one target software process prior to registration of the at least one target software process.

4. The computing device of claim 1, wherein the at least one software component is pre-compiled with the at least one target software process prior to registration of the at least one target software process.

5. The computing device of claim 1, wherein the access manager module is implemented as one of: a library linked to the at least one target software process; and an internal software component of the at least one target software process.

6. The computing device of claim 1, wherein the access manager module further comprises an interface definition comprising a set of named operations that are invoked by the data access request.

7. The computing device of claim 1, wherein the data access request is received from a second communication module executing on a remote client device.

8. The computing device of claim 7, wherein the first and second communication module are configured to communicate via remote procedure call protocol.

9. The computing device of claim 7, wherein the targeted data access request is generated by an on-demand client executing on the remote client device, and wherein the on-demand client comprises a command-line shell configured to receive a data access command from a user.

10. The computing device of claim 7, wherein the query data access request is generated by an automation client executing on the remote client device, wherein the automation client is configured to provide automated access to internal process data of the at least one target process.

11. The computing device of claim 7, wherein the access manager module is further configured to format the requested internal process data and transfer the formatted data to the remote client device.

12. A method for accessing internal process data of a running software process executing on at least one computing device in a networked computing system environment, the method comprising:
receiving a data access request at the at least one computing device;
routing the data access request to at least one registered target software process executing on the computing device;
routing the data access request to at least one software component of the at least one registered target software process, wherein the at least one software component is configured to support functionality of the at least one target software process;
capturing internal process data of the at least one software component as the at least one software component is executing on the at least one computing device; and
returning the captured internal process data to the at least one registered target software process.

13. The method of claim 12, further comprising calling an interface implementation of the at least one software component configured to capture the internal process data.

14. The method of claim 12, further comprising formatting the captured internal process data in accordance with a predefined formatting parameter of the data access request.

15. The method of claim 12, further comprising capturing one of structured and unstructured internal process data comprising data selected from a group including: primitive data types; hierarchical data types; composite data types; arrays; lists; trees; caches; objects; property bags; dictionaries; libraries; and configuration files.

16. The method of claim 12, further comprising analyzing a process identification parameter of the data access request prior to routing the data access request to the at least one registered target software process.

17. The method of claim 12, further comprising analyzing a unique component identification parameter of the data access request prior to routing the data access request to the at least one software component of the at least one registered target software process.

18. The method of claim 12, further comprising receiving the data access request at the at least one computing device as a remote procedure call.

19. The method of claim 18, further comprising routing the data access request to a plurality of registered target software processes executing on the computing device via one or more remote procedure call entry point vectors.

20. A computer readable storage medium having computer-executable instructions that, when executed by a computing device, cause the computing device to perform steps comprising:
receiving a data access request at the at least one computing device as a remote procedure call;
analyzing a process identification parameter of the data access request;
routing the data access request to at least one registered target software process executing on the computing device in accordance with the process identification parameter;
analyzing one or more unique component identification parameters of the data access request;
routing the data access request to at least one software component of the at least one registered target software process in accordance with the one or more unique component identification parameters, wherein the at least one software component is configured to support functionality of the at least one target software process;
calling an interface implementation of the at least one software component configured to capture the internal process data of the at least one software component as the at least one software component is executing on the at least one computing device, wherein the internal process data comprises one of structured and unstructured internal process data;
returning the captured internal process data to the at least one registered target software process; and
formatting the captured internal process data in accordance with a predefined formatting parameter of the data access request.
